(19) United States
(12) Patent Application Publication
(10) Pub. No.: US 2024/0092705 A1
(43) Pub. Date: Mar. 21, 2024

(54) A PROCESS FOR PREPARING FERTILIZER COMPOSITIONS

(71) Applicant: SELECT HARVESTS LIMITED, Thomastown (AU)

(72) Inventor: Upul GUNAWARDENA, Wemen (AU)

(21) Appl. No.: 18/024,725

(22) PCT Filed: May 20, 2022
(86) PCT No.: PCT/AU2022/050485

§ 371 Date: Mar. 3, 2023

(30) Foreign Application Priority Data
May 21, 2021 (AU) 2021901517

(51) Int. Cl. C05F 5/00; C05C 1/00; C05C 9/00; C05F 17/10; C05G 5/12; C05G 5/23

(52) U.S. Cl. CPC C05F 5/002; C05C 1/00; C05C 9/00; C05F 17/10; C05G 5/12; C05G 5/23

(57) ABSTRACT

Disclosed herein is process for preparing a solid fertilizer composition and a liquid fertilizer composition. The process may comprise providing a mixture comprising (i) almond fruit, (ii) water and (iii) a nitrogen-containing compound; agitating the mixture; and separating solids in the mixture from liquid.

### FIELD OF THE DISCLOSURE

The present disclosure broadly relates to a process for preparing fertilizer compositions, and in particular a process for preparing fertilizer compositions from almond fruit.

### BACKGROUND OF THE DISCLOSURE

Any discussion of the prior art throughout this specification should in no way be considered as an admission that such prior art is widely known or forms part of the common general knowledge in the field.

Fertilizers supply nutrients to soil and are therefore an important part of agriculture. There are a large number of different fertilizer types, ranging from liquid fertilizers for precision-type agriculture, through granular-type fertilizers to more crude fertilizers, such as various animal manures and composts. These fertilizers are used in different types of applications depending on different agronomic requirements.

The fruit of the almond is a drupe comprising an outer hull and a hard shell. Inside the shell is the edible seed, which is commonly referred to as a nut, being the only edible part of the fruit. Generally, the hull comprises 50-60% (w/w) of the fruit, the shell 10-15% (w/w) and the seed less than 30% (w/w). Almond hull has recently been classified as a food waste, and is currently used as cattle feed.

The present inventors have developed a process for preparing fertilizer compositions from almond fruit.

### SUMMARY OF THE DISCLOSURE

In a first aspect of the disclosure there is provided a process for preparing a solid fertilizer composition and a liquid fertilizer composition, the process comprising:
(a) providing a mixture comprising (i) almond fruit, (ii) water and (iii) a nitrogen-containing compound selected from: urea and an inorganic ammonium compound;
(b) agitating the mixture; and
(c) separating solids in the mixture from liquid, wherein the solids comprise the solid fertilizer composition and the liquid comprises the liquid fertilizer composition.

The mixture in step (a) may be provided by combining the almond fruit with the water, and then adding the nitrogen-containing compound.

The mixture in step (a) may be provided by combining the almond fruit with the nitrogen-containing compound, and then adding the water.

The mixture may be agitated for a period of time between about 1 day and about 14 days, or between about 1 day and about 10 days, or between about 1 day and about 7 days.

Agitating the mixture may comprise stirring.

The almond fruit may be present in the mixture in an amount between about 10% and about 45% by weight.

The nitrogen-containing compound may be present in the mixture in an amount between about 25% and about 45% by weight.

The water may be present in the mixture in an amount between about 35% and about 60% by weight.

The almond fruit may be particulate almond fruit.

The almond fruit may be ground or shredded almond fruit

The ground or shredded almond fruit may have a size that is less than about 10 mm, or less than about 5 mm, or between about 1 mm and about 5 mm.

The almond fruit may be almond hull, almond shell or a combination thereof in any ratio.

The inorganic ammonium compound may be ammonium nitrate or ammonium sulfate.

The nitrogen-containing compound may be urea.

The mixture in step (a) may further comprise olive pit.

The olive pit may be ground or shredded olive pit.

The olive pit may be present in the mixture in an amount between about 1% and about 10% by weight.

The mixture in step (a) may further comprise an acid, such as for example sulfuric acid.

The process may further comprise drying the solid fertilizer composition.

The process may further comprise granulating or pelletizing the solid fertilizer composition.

The process may be carried out under anaerobic conditions.

The process may be carried out in a digestion apparatus.

In a second aspect of the disclosure there is provided a liquid fertilizer composition and a solid fertilizer composition, whenever obtained by the process of the first aspect.

In a third aspect of the disclosure there is provided a process for preparing a liquid fungicide composition, the process comprising:
(a) providing a mixture comprising (i) shredded almond hull, (ii) water, (iii) urea and wettable sulphur;
(b) agitating the mixture; and
(c) separating solids in the mixture from liquid, wherein the liquid comprises the liquid fungicide composition.

In some forms, the shredded almond hull may have a size that is less than about 10 mm, or less than about 5 mm, or between about 2 mm and about 5 mm.

The almond hull may be present in the mixture in an amount between about 10% and about 15% by volume.

The urea and wettable sulphur may be present in the mixture in an amount between about 5% and about 7% by volume.

The water may be present in the mixture in an amount between about 75% and about 80% by volume.

The mixture may be agitated for a period of time of around 7 days.

### DEFINITIONS

The following are some definitions that may be helpful in understanding the description of the present disclosure. These are intended as general definitions and should in no way limit the scope of the present disclosure to those terms alone, but are put forth for a better understanding of the following description.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

In the context of this specification the term “about” is understood to refer to a range of numbers that a person of skill in the art would consider equivalent to the recited value in the context of achieving the same function or result.

Any numerical range recited herein is intended to include all sub-ranges of the same numerical precision subsumed within the recited range. For example, a range of 1.0 to 5.0 is intended to include all sub-ranges between (and including) the recited minimum value of 1.0 and the recited maximum value of 5.0, that is, having a minimum value equal to or greater than 1.0 and a maximum value equal to or less than 5.0, such as 2.1 to 4.5. Any maximum numerical limitation recited herein is intended to include all lower numerical limitations subsumed therein and any minimum numerical limitation recited herein is intended to include all higher numerical limitations subsumed therein.

### BRIEF DESCRIPTION OF THE DRAWINGS

FIG. 1: Schematic illustration of a process in accordance with one embodiment of the disclosure.

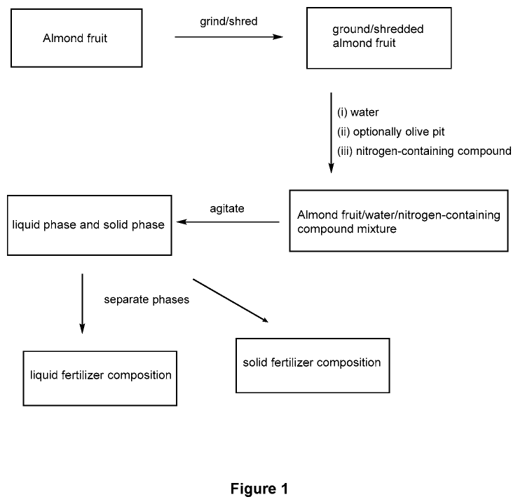

### DETAILED DESCRIPTION

In one aspect of the disclosure there is provided a process for preparing a solid fertilizer composition and a liquid fertilizer composition, the process comprising:
(a) providing a mixture comprising (i) almond fruit, (ii) water and (iii) a nitrogen-containing compound selected from: urea and an inorganic ammonium compound;
(b) agitating the mixture; and
(c) separating solids in the mixture from liquid, wherein the solids comprise the solid fertilizer composition and the liquid comprises the liquid fertilizer composition.

Fruit is an important reservoir of nutrients including carbohydrates, proteins, amino acids, fats and a range of inorganic nutrients such as potassium, calcium, phosphorous, magnesium and trace elements. In the process of the disclosure, nutrients are extracted from almond fruit into an aqueous liquid phase, whilst maintaining a balanced nutrient content in the solid phase such that multiple fertilizer compositions are obtained. Put another way, the process involves digestion of the almond fruit.

Reducing sugars are present in the plasma of almond hull cells and are also bonded to the hull cell walls. Free cations are partially bound to the reducing sugars and water molecules in the cell plasma. During hull splitting and harvesting the hull moisture level gradually reduces resulting in cations being associated with reducing sugars via dipole-dipole interactions similar to that of hydrogen bonding. Without wishing to be bound by any particular theory, it is believed that extraction of the nutrients into the aqueous liquid phase is facilitated by reaction of the nitrogen-containing compound with the reducing sugars. In the case of urea, reaction with the reducing sugars leads to the formation of ureides and concomitant liberation of the cations from their association with the reducing sugars.

The resultant liquid phase typically comprises greater than 20% of reducing sugars in the form of ureides, humates, soluble phenolics, cations including K⁺, Ca²⁺, Mg²⁺, Fe²⁺, Mn²⁺, Zn²⁺ and NH₄⁺, and anion-forming elements including boron, phosphorous and sulfur. The solid phase typically comprises insoluble phenolics, insoluble sugars and a range of insoluble cations and anions.

Significant features of the fertilizer compositions may be summarised as follows:
With the exception of nitrogen, all nutrients are obtained from almond fruit;
Reducing sugars are present;
Humic acid is present;
Crude proteins are present;
Cations including K⁺, Ca²⁺, Mg²⁺, Na⁺, Fe²⁺ and trace elements are present;
Anion-forming nutrients such as B, P, S are present;
All of the above are available in both the solid and liquid fertilizer compositions.

Unlike most other fertilizer production processes the process of the present disclosure does not produce carbon dioxide. In addition, the process utilises a waste product (preferably almond hull) and itself generates no waste. The process is therefore highly sustainable and environmentally friendly.

As compared to compost-type fertilizers, the liquid and solid fertilizers of the present disclosure are less bulky and therefore easier and safer to handle, and more cost effective to transport.

The fertilizer compositions also comprise a substantial amount of carbon (typically around 5% to 10% for the liquid fertilizer and around 35% to 45% for the solid fertilizer). Application of the fertilizers is therefore a cost-effective and efficient way to sequester carbon in soil. Application of soluble organic compounds such as sugars and humates also enhances the soil's microbial population

In one embodiment the mixture in step (a) may be provided by combining the almond fruit with the water, and then adding the nitrogen-containing compound. Alternatively, the almond fruit, water and nitrogen-containing compound may all be combined together. In another alternative embodiment the mixture in step (a) may be provided by combining the almond fruit with the nitrogen-containing compound, and then adding the water. The mixture is then agitated (typically by stirring).

The mixture may be agitated for a period of time which is sufficient to achieve a desired concentration of one or more nutrients extracted from the almond fruit in the liquid phase. Different nutrient concentrations may be obtained depending on the length of time over which step (b) is performed. The period of time may therefore be varied depending on the target market of the fertilizers and the nutrient concentrations required. In other embodiments the mixture may be agitated for a period of time which is sufficient to extract at least one nutrient from the almond fruit into the liquid phase. In other embodiments, the mixture may be agitated for a period of time which is sufficient to digest the almond fruit.

In some embodiments the mixture may be agitated for a period of time between about 1 day and about 14 days, or between about 1 day and about 10 days, or between about 1 day and about 7 days.

On completion of step (b) the solids are separated from the liquid to provide the liquid fertilizer composition and the solid fertilizer composition. The solids may be separated from the liquid by methods well known to those skilled in the art, such as for example filtration, centrifugation or sedimentation. Each composition may then be packaged or used as is. Alternatively, in some embodiments, following separation, the solid fertilizer composition is dried and/or granulated or pelletised.

The process may be carried out under anaerobic conditions. In some embodiments, the process is carried out in a digestion apparatus.

In some embodiments, the mixture may comprise olive pits. Inclusion of olive pits may boost the amount of phosphorous present in the fertilizer compositions. Preferably, the olive pits are ground or shredded prior to inclusion in the mixture. Where olive pit is included in the mixture, it may be combined with the almond fruit, followed by addition of the nitrogen-containing compound and then water.

The olive pit may be present in the mixture in an amount between about 1% and about 10% by weight, or in an amount between about 2% and about 8% by weight, or in an amount between about 4% and about 8% by weight, or in an amount of about 6% by weight.

The almond fruit may be present in the mixture in an amount between about 10% and about 45% by weight, or in an amount between about 10% and about 40% by weight, or in an amount between about 13% and about 38% by weight.

The nitrogen-containing compound may be present in the mixture in an amount between about 25% and about 45% by weight, or in an amount between about 25% and about 40% by weight, or in an amount between about 28% and about 38% by weight.

The water may be present in the mixture in an amount between about 35% and about 60% by weight, or in an amount between about 35% and about 55% by weight, or in an amount between about 38% and about 57% by weight.

The nitrogen-containing compound is selected from urea and an inorganic ammonium compound. Suitable inorganic ammonium compounds include, but are not limited to, ammonium sulfate, ammonium nitrate, ammonium chloride, ammonium fluoride, ammonium hexafluorophosphate, ammonium iodide, ammonium phosphate, ammonium sulfite and the like.

The mixture may further comprise an acid. The presence of acid may serve to neutralise the alkalinity of the hull. Suitable acids will be well known to those skilled in the art and include mineral acids, such as hydrochloric acid, nitric acid, sulfuric acid, hydroiodic acid, hydrobromic acid, perchloric acid, phosphoric acid, aqua regia and the like.

The almond fruit may be ground or shredded. In some embodiments, the almond fruit is ground or shredded to a size of less than about 10 mm, or less than about 5 mm, or between about 1 mm and about 5 mm, or between about 2 mm and about 5 mm. The almond fruit may be almond hull, almond shell, or a combination thereof in any ratio. In other embodiments the almond fruit may be in the form of a particulate. Almond hull and shell are by-products of the isolation of edible almond seed. As such, the process of the present disclosure turns waste into useful, high-value fertilizer products.

In some embodiments the ratio of almond fruit (based on average sugars) to urea is about 2:1. The ratio of almond fruit to urea may be determined based on the desired amount of nitrogen required in the fertilizer compositions.

In the case of the liquid fertilizer composition, it is preferred that the minimum nitrogen% in amine form is 6%, the minimum sugar level is 20%, and the ratio of nitrogen:organic compounds is approximately 1:1.

Below is a typical nutrient analysis of liquid and solid fertilizers prepared in accordance with a process of the disclosure:

| | Liquid fertilizer | Solid fertilizer |
|---|---|---|
| N (NH₄⁺) | 7% | 1.1% |
| N (NO₃⁻) | 16 ppm | 7 ppm |
| N (total) | 8% | 7% |
| P | 0.02% | 0.2% |
| K | 1% | 2.4% |
| Ca | 0.08% | 0.8% |
| Mg | 0.05% | 0.15% |
| Na | 0.014% | 0.04% |
| Fe | 200 ppm | 1800 ppm |
| Zn | 9 ppm | 33% |
| Mn | 12 ppm | 50 ppm |
| B | 26 ppm | 90 ppm |
| Total sugars | 33% | 27% |
| Total humates | 0.6% | 3% |
| Total organic carbon | 8% | 40% |

In some embodiments the liquid fertilizer may comprise any one or more of the following components in the amounts specified:

| Component | Amount |
|---|---|
| Total Nitrogen (% w/w) | 2 to 9 |
| Total Phosphorous (% w/w) | 0.05 to 0.4 |
| Total Potassium (% w/w) | 0.2 to 1.5 |
| Total Sulfur (% w/w) | 1 to 5 |
| Total Calcium (% w/w) | 0.05 to 0.2 |
| Total Magnesium (% w/w) | 0.05 to 0.3 |
| Total Sodium (% w/w) | 0.01 to 0.03 |
| Total Iron (ppm w/w) | 50 to 300 |
| Total Manganese (ppm w/w) | 20 to 50 |
| Total Zinc (ppm w/w) | 5 to 15 |
| Total Copper (ppm w/w) | 0.5 to 2 |
| Total Cobalt (ppm w/w) | 2 to 20 |
| Total Boron (ppm w/w) | 5 to 40 |
| Total Molybdenum (ppm w/w) | 0.05 to 0.3 |
| Total Organic Carbon (%) | 2 to 15 |
| Ammonium Nitrogen (% w/w) | 1 to 10 |
| Nitrate Nitrogen (ppm w/w) | 1 to 60 |
| Humic Acid (%) | 0.1 to 1 |
| Sugar (%) | 5 to 35 |

In some embodiments the solid fertilizer may comprise any one or more of the following components in the amounts specified:

| Component | Amount |
|---|---|
| Total Nitrogen (% w/w) | 3 to 10 |
| Total Phosphorous (% w/w) | 0.1 to 0.3 |
| Total Potassium (% w/w) | 1 to 3 |
| Total Sulfur (% w/w) | 2 to 9 |
| Total Calcium (% w/w) | 0.3 to 1 |
| Total Magnesium (% w/w) | 0.1 to 0.2 |
| Total Sodium (% w/w) | 0.02 to 0.05 |
| Total Iron (ppm w/w) | 500 to 2000 |
| Total Manganese (ppm w/w) | 40 to 90 |
| Total Zinc (ppm w/w) | 20 to 40 |
| Total Copper (ppm w/w) | 8 to 15 |
| Total Cobalt (ppm w/w) | 5 to 60 |
| Total Boron (ppm w/w) | 20 to 50 |
| Total Molybdenum (ppm w/w) | 1 to 7 |
| Total Organic Carbon (%) | 25 to 50 |
| Ammonium Nitrogen (% w/w) | 0.5 to 7 |
| Nitrate Nitrogen (ppm w/w) | 2 to 30 |
| Humic Acid (%) | 0.5 to 5 |
| Sugar (%) | 10 to 50 |

### EXAMPLES

The present disclosure is further described below by reference to the following non-limiting examples.

Solid and liquid fertilizer compositions were prepared in accordance with the following processes:

### Example 1: Preparation of Fertilizer Compositions Using Urea

Step 1: Almond hull was shredded into pieces having sizes between 2 mm and 5 mm
Step 2: 6 kgs of shredded almond hull was weighed out
Step 3: 2 kgs of shredded olive pit was weighed out
Step 4: The shredded almond hull and shredded olive pit were transferred into a 100 L drum
Step 5: 4 kgs of urea was added to the drum and the resulting mixture was mixed thoroughly
Step 6: 40 L of water were added to the drum
Step 7: The mixture was agitated with stirring
Step 8: 50 ml liquid samples were removed every 24 hrs for 7 days
Step 9: At the end of day 7, the liquid phase and solid phase were separated
Step 10: The solid phase was compressed to remove liquid
Step 11: The solid phase was then sun-dried for about 6 to 8 hrs

### Example 2: Preparation of Fertilizer Compositions Using Ammonium Nitrate

Step 1: Almond hull was shredded into pieces having sizes between 2 mm and 5 mm
Step 2: 6 kgs of shredded almond hull was weighed out
Step 3: 2 kgs of shredded olive pit was weighed out
Step 4: The shredded almond hull and shredded olive pit were transferred into a 100 L drum
Step 5: 4 kgs of ammonium nitrate was added to the drum and the resulting mixture was mixed thoroughly
Step 6: 40 L of water were added to the drum
Step 7: The mixture was agitated with stirring
Step 8: 50 ml liquid samples were removed every 24 hrs for 7 days
Step 9: At the end of day 7, the liquid phase and solid phase were separated
Step 10: The solid phase was compressed to remove liquid
Step 11: The solid phase was then sun-dried for about 6 to 8 hrs

### Example 3: Preparation of Fertilizer Compositions Using Ammonium Sulfate

Step 1: Almond hull was shredded into pieces having sizes between 2 mm and 5 mm
Step 2: 6 kgs of shredded almond hull was weighed out
Step 3: 2 kgs of shredded olive pit was weighed out
Step 4: The shredded almond hull and shredded olive pit were transferred into a 100 L drum
Step 5: 4 kgs of ammonium sulfate was added to the drum and the resulting mixture was mixed thoroughly
Step 6: 40 L of water were added to the drum
Step 7: The mixture was agitated with stirring
Step 8: 50 ml liquid samples were removed every 24 hrs for 7 days
Step 9: At the end of day 7, the liquid phase and solid phase were separated
Step 10: The solid phase was compressed to remove liquid
Step 11: The solid phase was then sun-dried for about 6 to 8 hrs

The above described digestion technology was developed to extract in-organic nutrients (K, P, Ca, Mg, Fe, B, Zn, etc. . . . ) and organic nutrients (soluble organic such as sugars, humates, flavonoids and phenols) into liquid phase. The above described developments in hull digestion technology are focused on urea extraction of hull nutrients, and are focused on soluble in-organics (K, P, Ca, Mg, Fe, B, Zn, etc. . . . ), sugars and humates as soluble organics.

In another aspect of the present disclosure, the digestion technology disclosed herein is also configured to produce a fungicidal product.

Wettable sulphur is a useful product for horticultural crops. It is used to manage some fungal diseases as well as some pests. In some embodiments, the hull digestion technology disclosed is configured to react with wettable sulphur. Reactants for the product disclosed herein may include urea, hull, wettable sulphur, and/or water.

Preparation of Fungicidal Composition Using Wettable Sulphur May Comprise:
Step 1: Shredding almond hull into pieces having sizes ranging from around 2 mm to 5 mm.
Step 2: Weighing out around 6 kgs of shredded almond hull.
Step 3: Transferring the shredded almond hull into a drum (e.g. 100 L capacity drum).
Step 4: Adding around 3 kgs of urea and 3 kgs of wettable sulphur to the drum and mixing the resultant composition.
Step 5: Adding 40 L of water to the drum.
Step 6: Agitating the mixture in the drum by, for example, stirring the mixture for a period of time (e.g. around 7 days).
Step 8: Separating the liquid phase from the solid phase.
Step 9: Optionally compressing the solid phase to remove liquid.
Step 10: Discarding the solid phase.

Summarised herein is the combined effect of sulphur with urea. Wettable sulphur is a low cost, multicide fungicide, which is widely used to control a number of fungal diseases as well as mite population in, for example, Australian horticulture. Generally wettable sulphur has “zero” withholding period. This allows for it to be applied closer to harvest, and therefore causes minimal delay to a specified harvest date. However, wettable sulphur has limitations, in that it can cause leaf or a bud burn effect.

The hull digestion technology disclosed herein may include wettable sulphur in the mixture. Ureide molecule may disperse sulphur in the solution, as demonstrated pictorially below.

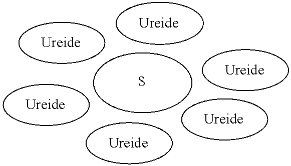

This dispersion allows uniform distribution of sulphur in the solution, and allow sulphur particle to settle substantially uniformly on a leaf and/or fruit surface.

The benefits of using wettable sulphur in hull digested solution disclosed herein are substantial. Examples include that the wettable sulphur may be uniformly distributed in the solution, and it minimises the above referenced leaf/bud burning effect. Further, the hull digestion technology disclosed herein may solubilise certain flavonoids and phenolic substances of hull, and therefore those substances may be available in the liquid phase. Also, phenolic and flavanoids have fungicidal properties. As such, the combined effect of wettable sulphur with flavonoids and phenolic substances facilitates a product with fungicidal properties.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

1. A process for preparing a solid fertilizer composition and a liquid fertilizer composition, the process comprising:
(a) providing a mixture comprising (i) almond fruit, (ii) water and (iii) a nitrogen-containing compound selected from: urea and an inorganic ammonium compound;
(b) agitating the mixture;
(c) separating solids in the mixture from liquid by a method selected from filtration, centrifugation and sedimentation, wherein the solids comprise the solid fertilizer composition and the liquid comprises the liquid fertilizer composition; and
(d) providing the solid fertilizer composition and the liquid fertilizer composition.

2. The process of claim 1, wherein the mixture in step (a) is provided by combining the almond fruit with the water, and then adding the nitrogen-containing compound.

3. The process of claim 1, wherein the mixture in step (a) is provided by combining the almond fruit with the nitrogen-containing compound, and then adding the water.

4. The process of claim 1, wherein the mixture is agitated for a period of time between about 1 day and about 14 days, or between about 1 day and about 10 days, or between about 1 day and about 7 days.

5. The process of claim 1, wherein agitating the mixture comprises stirring.

6. The process of claim 1, wherein the almond fruit is present in the mixture in an amount between about 10% and about 45% by weight.

7. The process of claim 1, wherein the nitrogen-containing compound is present in the mixture in an amount between about 25% and about 45% by weight.

8. The process of claim 1, wherein the water is present in the mixture in an amount between about 35% and about 60% by weight.

9. The process of claim 1, wherein the almond fruit is particulate almond fruit, ground almond fruit, or shredded almond fruit.

10. (canceled)

11. The process of claim 9, wherein the ground or shredded almond fruit has a size that is less than about 10 mm, or less than about 5 mm, or between about 1 mm and about 5 mm.

12. The process of claim 1, wherein the almond fruit is almond hull, almond shell or a combination thereof in any ratio.

13. The process of claim 1, wherein the inorganic ammonium compound is ammonium nitrate or ammonium sulfate and/or the nitrogen-containing compound is urea.

14. (canceled)

15. The process of claim 1, wherein the mixture in step (a) further comprises olive pit.

16. The process of claim 15, wherein the olive pit is present in the mixture in an amount between about 1% and about 10% by weight.

17. The process of claim 15, wherein the olive pit is ground or shredded olive pit.

18. The process of claim 1, wherein the mixture further comprises an acid.

19. The process of claim 18, wherein the acid is a mineral acid.

20. The process of claim 1, further comprising drying the solid fertilizer composition.

21. The process of claim 1, further comprising granulating or pelletizing the solid fertilizer composition.

22. The process of claim 1, wherein the process is carried out under anaerobic conditions.

23. (canceled)

24. (canceled)
